(19) United States
(12) Patent Application Publication
(10) Pub. No.: US 2016/0059609 A1
(43) Pub. Date: Mar. 3, 2016

(54) Presenting Media Content to Visually Enhance a Pop-up Book

(71) Applicant: Google, Inc., Mountain View, CA (US)

(72) Inventors: Ali Javan Javidan, Sunnyvale, CA (US); Frank Vincent Savino, San Carlos, CA (US); Norbert B. Tydingco, Newark, CA (US); Mark Anthony Zarich, Oakland, CA (US); Aaron Arthur Weiss, Mountain View, CA (US)

(21) Appl. No.: 14/591,583

(22) Filed: Jan. 7, 2015

Related U.S. Application Data
(60) Provisional application No. 62/044,133, filed on Aug. 29, 2014.

(51) Int. Cl. B42D 1/00

(52) U.S. Cl. CPC B42D 1/004

(57) ABSTRACT

This document describes a media enhanced pop-up book and techniques and devices for presenting media content to visually enhance a pop-up book. A media enhanced pop-up book includes physical pages and pop-pages attached to the physical pages. The media enhanced pop-up book further includes a pop-up system configured to cause the pop-up pages to pop-up in front of a display of a computing device as the physical pages are turned. A story controller, implemented at the computing device, detects a pop-up page of the media-enhanced pop-up book when the pop-up page pops-up in front of the display, and presents media content associated with the detected pop-up page on the display. The media content is viewable through the pop-up page and thus visually enhances the pop-up page.

### PRIORITY APPLICATION

This application is a non-provisional of and claims priority under 35 U.S.C. §119(e) to U.S. Patent Application Ser. No. 62/044,133, titled “Presenting Media Content to Visually Enhance a Pop-Up Book,” and filed on Aug. 29, 2014, the disclosure of which is incorporated by reference herein in its entirety.

### BACKGROUND

Pop-up books engage the reader by providing the reader with three-dimensional elements that pop-up out of the book. Recently some pop-up books, such as children's books, may include an audio component that further enriches the experience of reading the pop-up book. For example, the audio component may include physical control buttons and a speaker attached to the side of the book. The pop-up book itself may include words, pictures, and written instructions that tell the user to push specific buttons on the audio component to cause audio to be played via the speaker.

### SUMMARY

This document describes a media enhanced pop-up book and techniques and devices for presenting media content to visually enhance a pop-up book. A media enhanced pop-up book includes physical pages and pop-pages attached to the physical pages. The media enhanced pop-up book further includes a pop-up system configured to cause the pop-up pages to pop-up in front of a display of a computing device as the physical pages are turned.

A story controller, implemented at the computing device, detects a pop-up page of the media-enhanced pop-up book when the pop-up page pops-up in front of the display, and presents media content associated with the detected pop-up page on the display. The media content is viewable through the pop-up page and thus visually enhances the pop-up page.

This summary is provided to introduce simplified concepts concerning a media enhanced pop-up book and techniques and devices for presenting media content to visually enhance a pop-up book, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of a media enhanced pop-up book and techniques and devices for presenting media content to visually enhance a pop-up book are described with reference to the following drawings. The same numbers are used throughout the drawings to reference like features and components:

FIG. 1 is an illustration of an example environment in which a pop-up book and a computing device to visually enhance the pop-up book may be embodied.

FIG. 2a illustrates a detailed-example example of a pop-up system of the book in accordance with one or more implementations.

FIG. 2b illustrates an example of using the pop-up system to turn to a next page in the book.

FIG. 3 illustrates a detailed example of a computing device configured to present media content on a display to visually enhance a pop-up page in accordance with various implementations.

FIG. 4 illustrates a system in an example implementation in which a story controller detects a pop-up page when positioned in front of a display, and presents media content associated with the pop-up page on the display.

FIG. 5 illustrates an example of detecting a pop-up page of a book in accordance with one or more implementations.

FIG. 6 illustrates an additional example of detecting a pop-up page of a book in accordance with one or more implementations.

FIG. 7 illustrates an example of adjusting the presentation of media content on a display in accordance with one or more implementations.

FIG. 8 illustrates an example method of causing a pop-up page to pop-up in front of a display.

FIG. 9 illustrates an example method of presenting media content to visually enhance a pop-up page using NFC tags.

FIG. 10 illustrates an example method of presenting media content to visually enhance a pop-up page using a pattern of touch input points.

FIG. 11 illustrates various components of an example computing system that can be implemented as any type of computing device as described with reference to the previous FIGS. 1-10 to implement book 102 or computing device 104.

### DETAILED DESCRIPTION

Overview

This document describes a media enhanced pop-up book and techniques and devices for presenting media content to visually enhance a pop-up book. A media enhanced pop-up book includes physical pages and pop-up pages attached to the physical pages. The media enhanced pop-up book further includes a pop-up system configured to cause the pop-up pages to pop-up in front of a display of a computing device as the physical pages are turned.

Example Environment

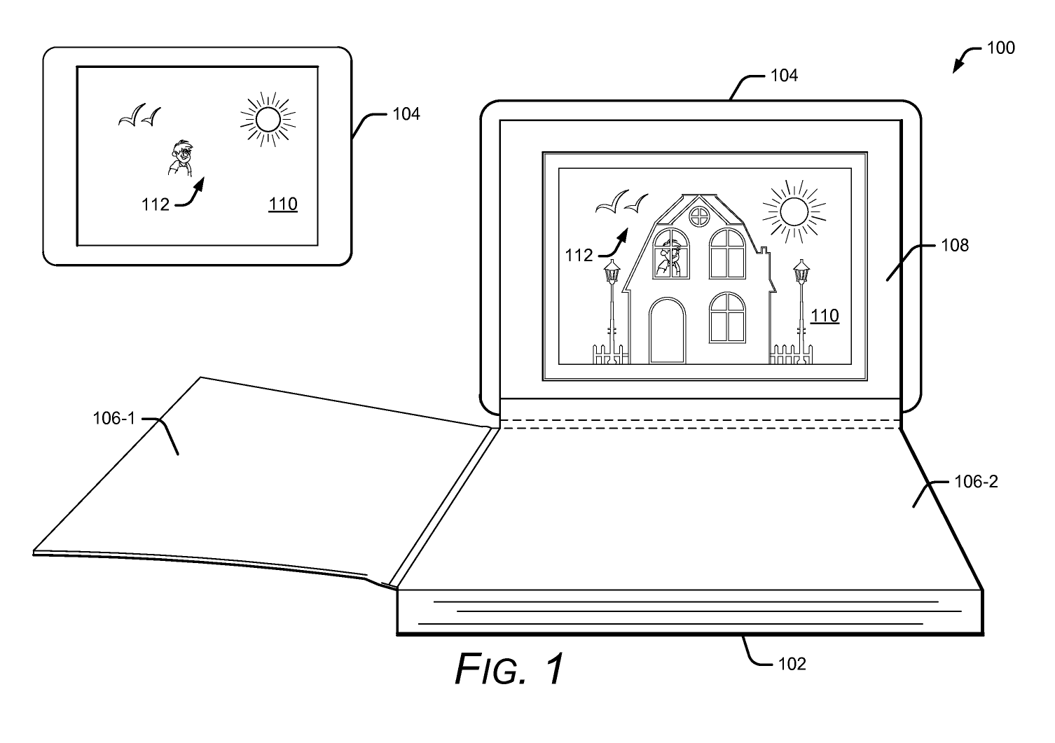

FIG. 1 is an illustration of an example environment 100 in which a media enhanced pop-up book and a computing device configured to present media content to visually enhance the pop-up book, may be embodied. Environment 100 includes a media enhanced pop-up book (“book”) 102 and a computing device 104.

Book 102 is a physical book and includes physical pages (“pages”) 106, which may be implemented with a physical material such as paper, cardboard, or plastic, to name just a few. In this example, book 102 is open to a first page 106-1 and a second page 106-2 that is adjacent to first page 106-1. As described throughout, a “first page” corresponds to the page positioned on the left of book 102 when the book is open, and a “second page” corresponds to the page on the right when the book is open. Of course, it is to be appreciated that if the user turns to a previous page in book 102, by turning first page 106-1, that the backside of first page 106-1 will be positioned on the right side of book 102 adjacent to a previous page of book 102 positioned on the left. Each page 106 of book 102 may include text or images like many standard physical books.

Book 102 includes three-dimensional pop-up pages (“pop-up pages”) 108, which pop-up and out of book 102 as the reader turns pages 106 of book 102. The pop-up pages 108 may be made from any type of sturdy material, such as cardboard, plastic, and so forth.

Each pop-up page 108 is associated with two adjacent pages of book 102. For example, in FIG. 1, pop-up page 108 is associated with first page 106-1 positioned on the left, and second page 106-2 positioned on the right. When book 102 is opened to pages 106-1 and 106-2, pop-up page 108 pops-up substantially perpendicular to pages 106-1 and 106-2.

Pop-up page 108 includes artwork that enables media content displayed on a display 110 of computing device 104 to be viewable through the artwork when display 110 is positioned behind book 102. In this example, the artwork includes a house, a fence, and lampposts. The material of pop-up page 108 around the house, fence, and lampposts is cut-out which enables display 110, positioned behind pop-up page 108, to be partially viewable. In addition, the areas corresponding to windows and doors in the house are also cut-out. In some cases, instead of cut-outs, pop-up page 108 may include transparent or semi-transparent portions (e.g., pieces of vellum) which enables display 110 to be viewable through pop-up page 108.

Display 110 of computing device 104 may be positioned behind book 102, such that it is substantially-perpendicular to book 102 when book 102 is lying flat, such as on a table. In some cases, book 102 may include a stand or holder for computing device 104, to enable display 110 to be positioned behind book 102.

As discussed in greater detail below, pop-up page 108 is controlled to pop-up and out of book 102 directly in front of display 110. When this occurs, computing device 104 detects pop-up page 108, and presents media content 112 on display 110 that is associated with pop-up page 108. For example, computing device 104 may present different media content 112 for each pop-up page 108.

Media content 112 presented on display 110 visually enhances the artwork of pop-up page 108. For example, computing device 104 can present media content 112 in areas of display 110 that is viewable through pop-up page 108 (e.g., areas which include cut-outs of transparent material), and which is specifically indented to visually enhance the artwork of pop-up page 108.

In FIG. 1, display 110 presents media content 112 that includes images or video of a sun, birds, and a child, which visually enhance and bring to life the artwork of pop-up page 108. For example, the sun and birds and bring to life the area around the house of pop-up page 108, and the child appears to be in the window of the house. Note that the sun, the birds, and the child may be implemented as non-moving images, or as video. For example, when implemented as video, the child could wave or talk and the birds could fly across the sky.

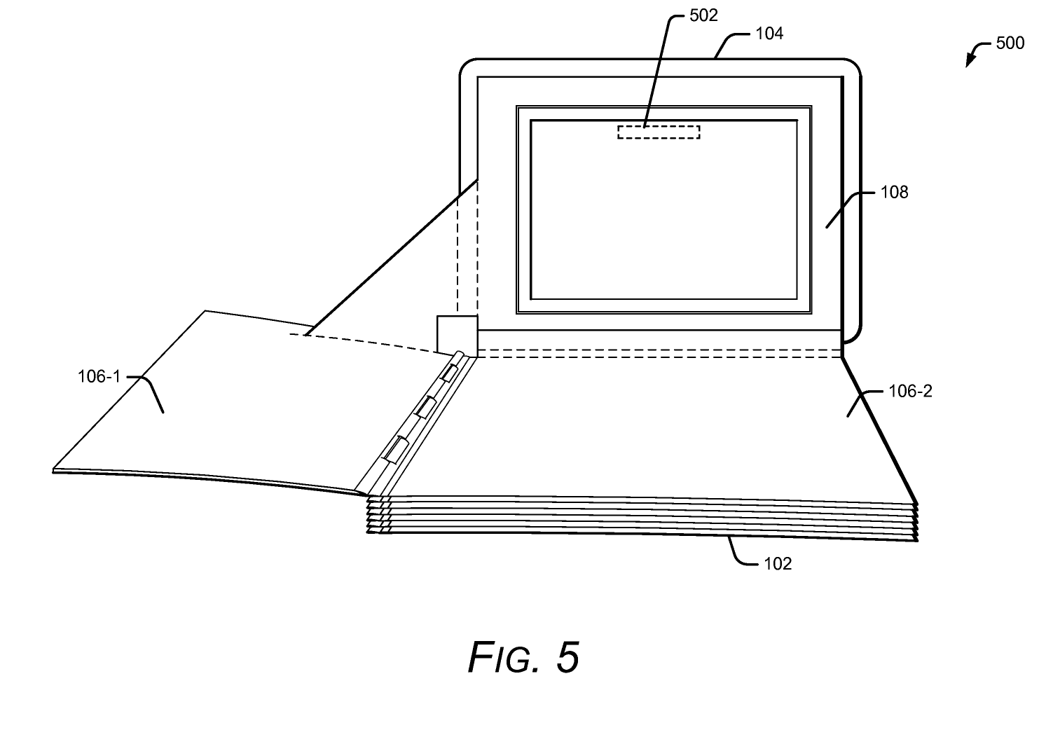

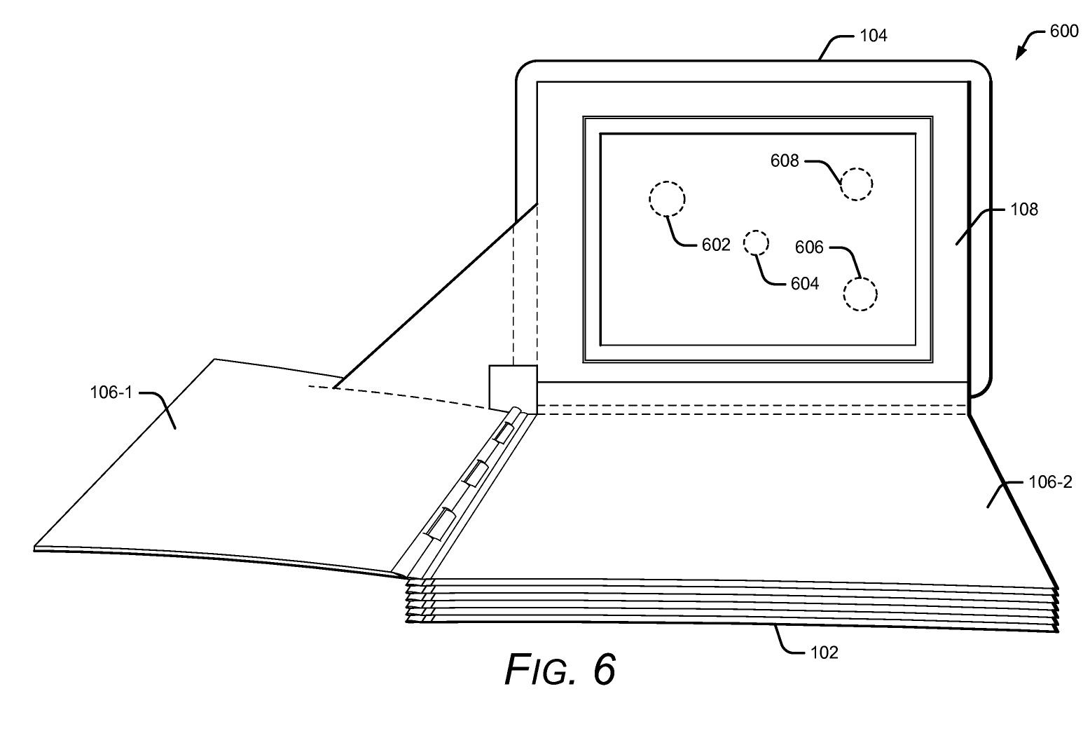

In order to present associated media content 112 for each pop-up page 108, computing device 104 is configured to identify pop-up page 108 when it pops-up in front of display 110. To enable identification of pop-up page 108, electronic identifiers may be embedded within each pop-up page 108 which are detectable by computing device 104. For example, in some cases near field communication (NFC) tags may be embedded into pop-up page 108, which is discussed in more detail below with regards to FIG. 5. Alternately or additionally, patterns of touch input points may be embedded into pop-up pages 108, which is discussed in more detail below with regards to FIG. 6.

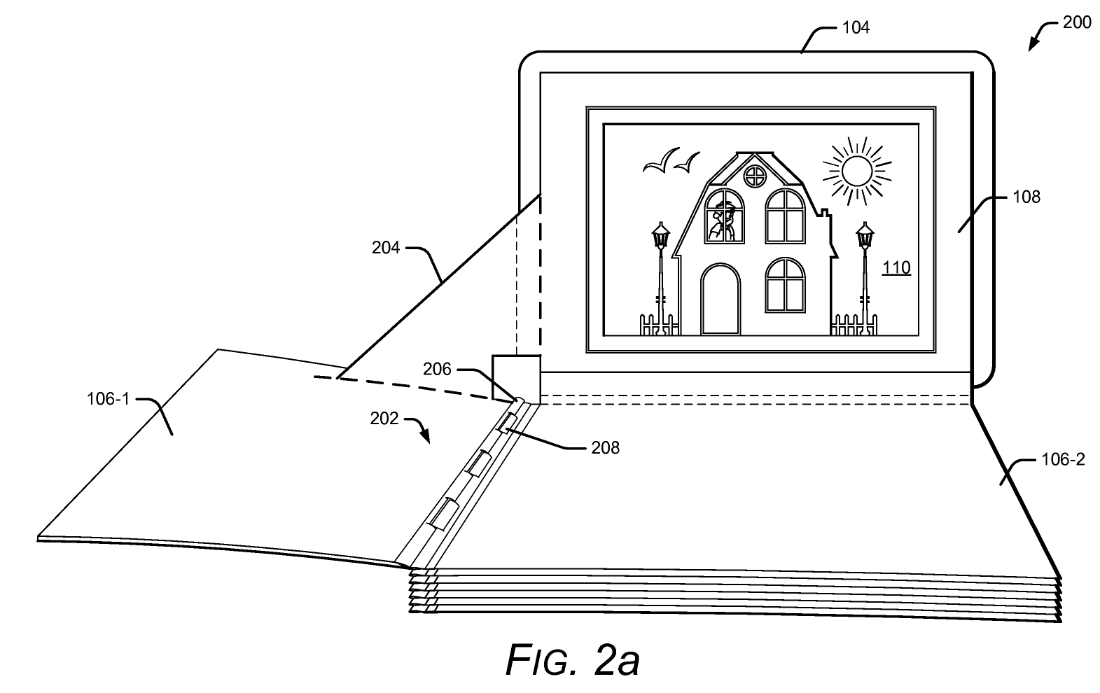

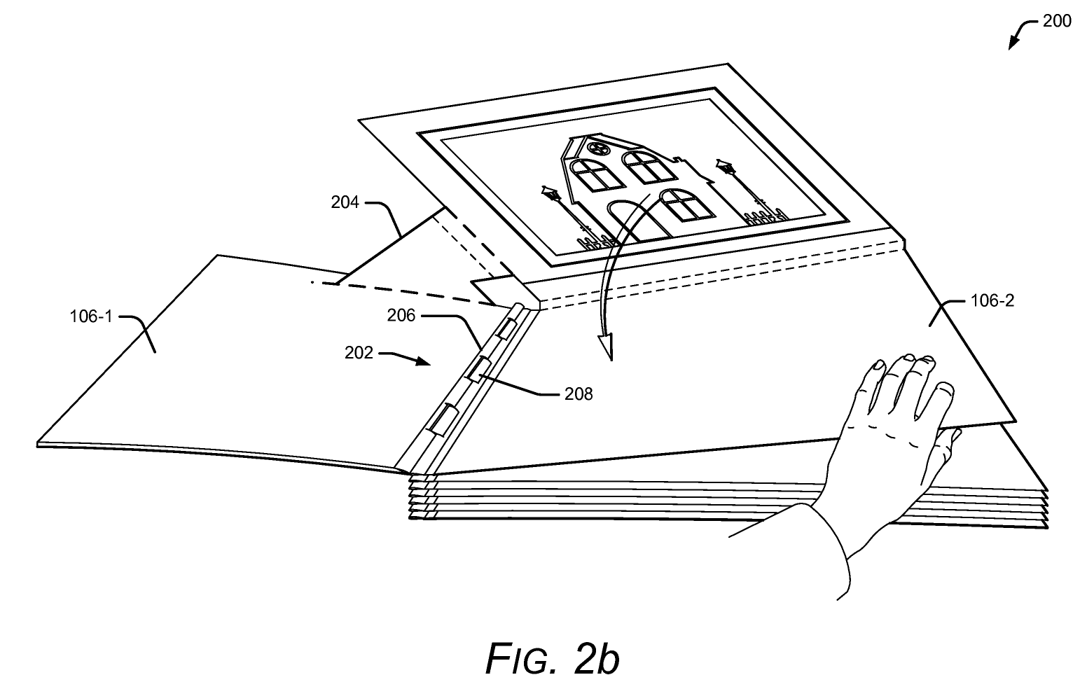

FIG. 2a illustrates a detailed-example example 200 of a pop-up system of book 102 in accordance with one or more implementations.

In example 200, the pop-up system of book 102 causes pop-up pages 108 to pop-up directly in front of display 110 as pages 106 are turned. The pop-up system ensures that each pop-up page 108 is precisely positioned such that the media content presented on display 110 is viewable behind each pop-up page 108. Note that if pop-up page 108 is not perfectly aligned with display 110, then the media content may not be viewable through pop-up page 108. For example, in FIG. 1, the child presented in the window may not be viewable if pop-up page 108 is rotated, even slightly, to the left or right relative to display 110.

The pop-up system includes a page-turning mechanism 202 and a pop-up mechanism 204. Page-turning mechanism 202 enables the reader to effortlessly turn pages 106 of book 102 forward or backward. The act of turning pages 106 causes pop-up mechanism 204 to force pop-pages 108 to pop-up in in front of display 110.

In example 200, page-turning mechanism 202 is implemented as a “double-hinged” page-turning mechanism, and includes first hinges 206, which rotate on a first fulcrum, and second hinges 208, which rotate on a second fulcrum. First hinges 206 enable first page 106-1 to be turned forward or backward in book 102. Similarly, second hinges 208 enable second page 106-2 to be turned forward or backward in book 102. As described here, turning a page “forward” refers to the act of turning to a “next page” in book 102, whereas turning a page “backward” refers to the act of turning to a “previous page” in book 102.

Consider, for example, FIG. 2b which illustrates an example 200 of using the pop-up system to turn to a next page in book 102. In this example, a user turns second page 106-2 forward in book 102. Second hinges 208 enable the rotation of second page 106-2 as the user turn page 106-2. Note that first hinges 206 are not utilized for this page turn. However, if the user were to turn first page 106-1 backward in book 102, then first hinges 206 would enable the rotation, while second hinges 208 would not be utilized.

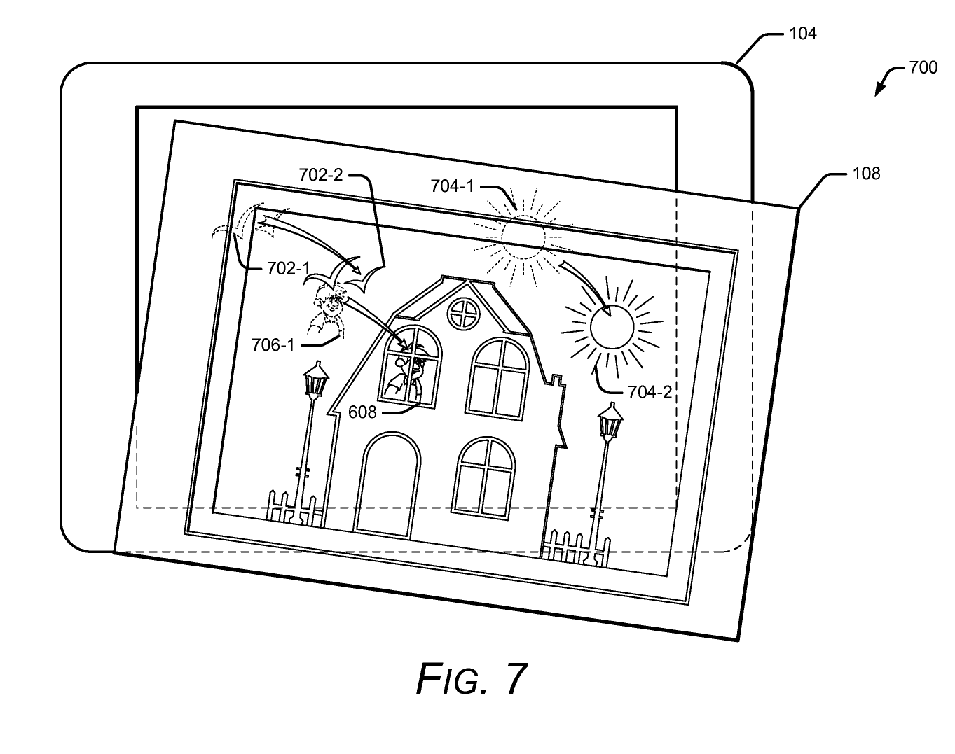

Using two hinges enables better control over the positioning of pop-up page 108 with display 110. Note, however, that book 102 is not limited to using a double-hinged page-turning mechanism. For instance, in some cases page-turning mechanism 202 may be implemented with a single hinge. However, using a single hinge may over constrain the pop-up system, which over time may cause wear and tear on page-turning mechanism 202. Additionally, using a single hinge may decrease the accuracy in the positioning of pop-up page 108 relative to display 110. Thus, when a single hinge is used, computing device 104 may need to adjust the presentation of the media content on display 110, such as by rotating the media content to the left or the right to align the media content with the orientation of pop-up page 108. An example of adjusting the presentation of the media content is discussed in more detail below, with regards to FIG. 7.

Pop-up mechanism 204 is configured to cause pop-up page 108 to pop-up and out of book 102 in front of display 110 as the user turns pages 106 of book 102. In this example, pop-up mechanism 204 is triangular-shaped and attached to first page 106-1 and to pop-up page 108. Pop-up page 108 is further attached to second page 106-2. The triangular-shape of pop-up mechanism 204 is designed to give pop-up page 108 a “preload” to seamlessly pop-up and out of book 102, and to fold back down into book 102, as pages are turned.

Thus, as the user turns forward or backward in book 102, pop-up mechanism 204 causes pop-up page 108 to pop-up and out of book 102. For example, when pages 106-1 and 106-2 are turned to by the user, either by turning forward in book 102 using first page 106-1 or turning backward in book 102 using second page 106-2, pop-up mechanism 204 causes pop-up page 108 to pop-up and out of book 102.

Similarly, pop-up mechanism 204 causes pop-up page 108 to fold back down into book 102 as the user turns to a next or previous page 106. In FIG. 2b, for example, as the user turns to a next page, pop-up mechanism 204 causes pop-up page 108 to fold into book 102 on top of second page 106-2.

In one or more implementations, the positioning of pop-up page 108 relative to display 110 can be controlled by modifying the position at which pop-up mechanism 204 attaches to first page 106-1. For example, pop-up mechanism 204 may be adjusted further from, or closer to, the top edge of first page 106-1. Adjusting this position enables control over the registration of pop-up page 108 with computing device 104.

In one or more implementations, the orientation of first page 106-1 is skewed relative to second page 106-2, such that book 102 does not fold open straight. For example, page 106-1 may be skewed slightly up or down from page 106-2 when pages 106-1 and 106-2 are open. Doing so, in combination with where pop-up mechanism 204 attaches to page 106-1, enables the pop-up system to force pop-up pages 108 to pop-up with very good registration to display 110 of computing device 104.

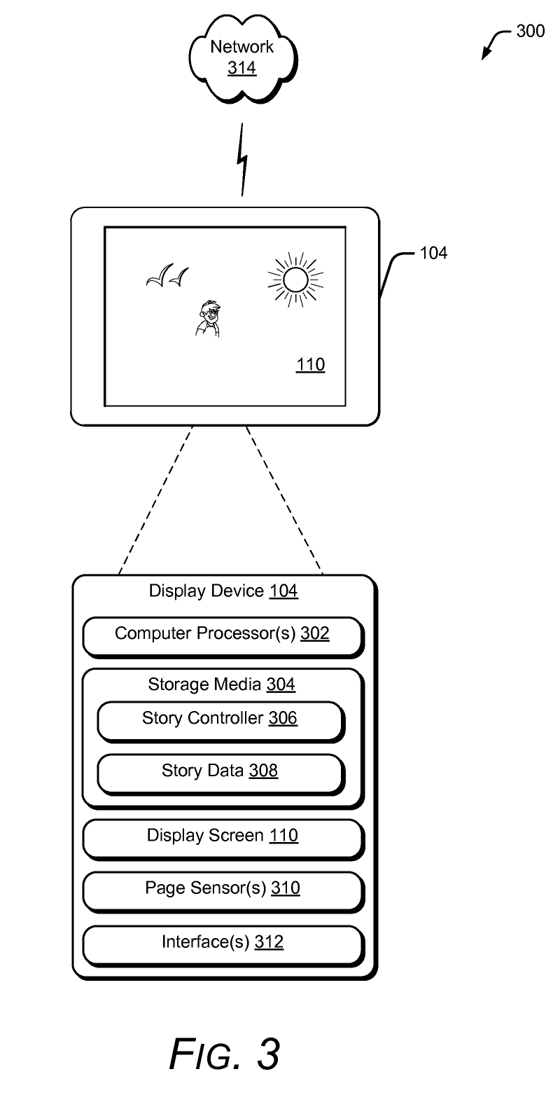

FIG. 3 illustrates a detailed example 300 of computing device 104 configured to present media content on display 110 to visually enhance pop-up page 108 in accordance with various implementations. In this example, computing device 104 is illustrated as a tablet-computing device. Note, however, that computing device 104 may be configured in a variety of different ways. Computing device 104, for instance, may be configured as a desktop computer, a laptop computer, a smartphone, a television device, an entertainment device, a gaming device, or any other type of device with a display. Thus, computing device 104 may range from full resource devices with substantial memory and processor resources (e.g., desktop computers) to a low-resource device with limited memory and/or processing resources (e.g., smartphones).

As described above, computing device 104 includes a display 110 that, when positioned behind book 102, can be controlled to present media content, such as images or video, that interact with and visually enhance pop-up page 108 of book 102. In one or more implementations, display 110 is implemented as a multi-touch display, such as a capacitive multi-touch display, that can detect multi-touch input.

Computing device 104 includes one or more computer processors 302 and computer-readable storage media (storage media) 304. Applications and/or an operating system (not shown) embodied as computer-readable instructions on storage media 304 can be executed by computer processors 302 to provide some or all of the functionalities described herein. Storage media 304 also includes a story controller 306 and story data 308, which will be described in more detail below.

In order to determine the current page of book 102 that is open, computing device 104 may include one or more page sensors 310. Page sensor 310 can be implemented as a variety of different types of sensors. In one or more implementations, page sensor 310 is implemented as a near field communication (NFC) sensor. Near field communication is a set of standards that enable devices to establish radio communication with each other by touching two devices together, or by bringing the devices within close proximity to each other, usually no more than a few inches. Additionally, communication is possible between an NFC sensor and an unpowered NFC chip, called an NFC tag. Thus, the NFC sensor can detect NFC tags embedded in pop-up page 108 when pop-up page 108 pops-up in front of display 110, further discussion of which can be found with reference to FIG. 5, below.

Computing device 104 may also include interface(s) 312 that enable wired and/or wireless communication of data over a network 314. Interfaces 312 can include wireless personal-area-network (WPAN) radios compliant with various WPAN standards, such as IEEE 802.15 (also referred to as Bluetooth™) standards, infrared data association (IrDA) standards, or wireless USB standards, to name just a few. Interfaces 312 can also include, by way of example and not limitation, wireless local-area-network (WLAN) radios compliant with any of the various IEEE 802.11 (also referred to as WiFi™) standards, wireless-wide-area-network (WWAN) radios for cellular telephony, wireless-metropolitan-area-network (WMAN) radios compliant with various IEEE 802.15 (also referred to as WiMAX™) standards, and wired local-area-network (LAN) Ethernet transceivers. In one or more implementations, interfaces 312 may be able to directly connect to book 102 via a wired or wireless connection.

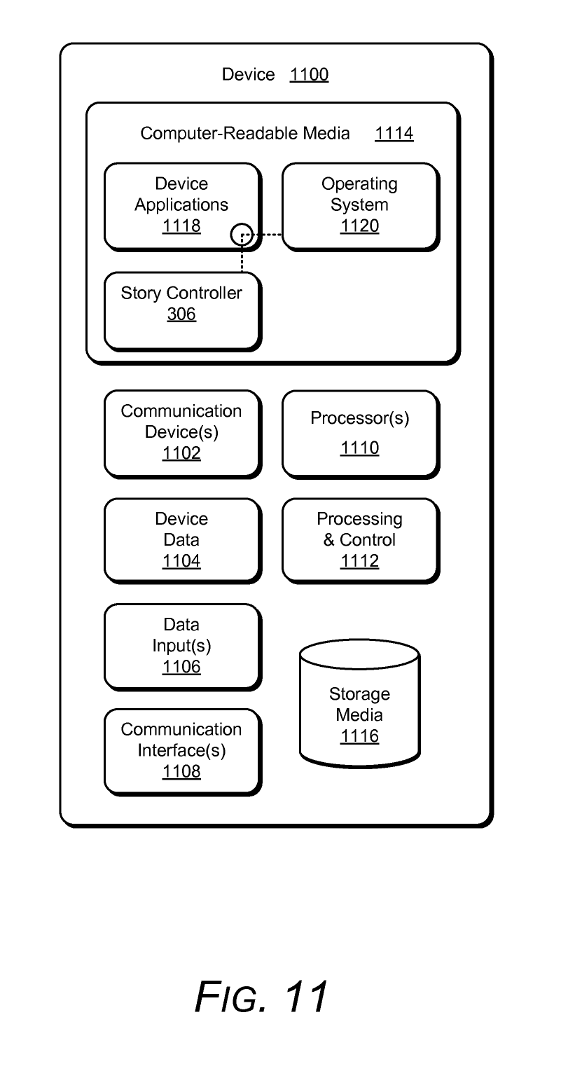

Computing device 104 can also be implemented with any number and combination of differing components as further described with reference to the example device shown in FIG. 11, below.

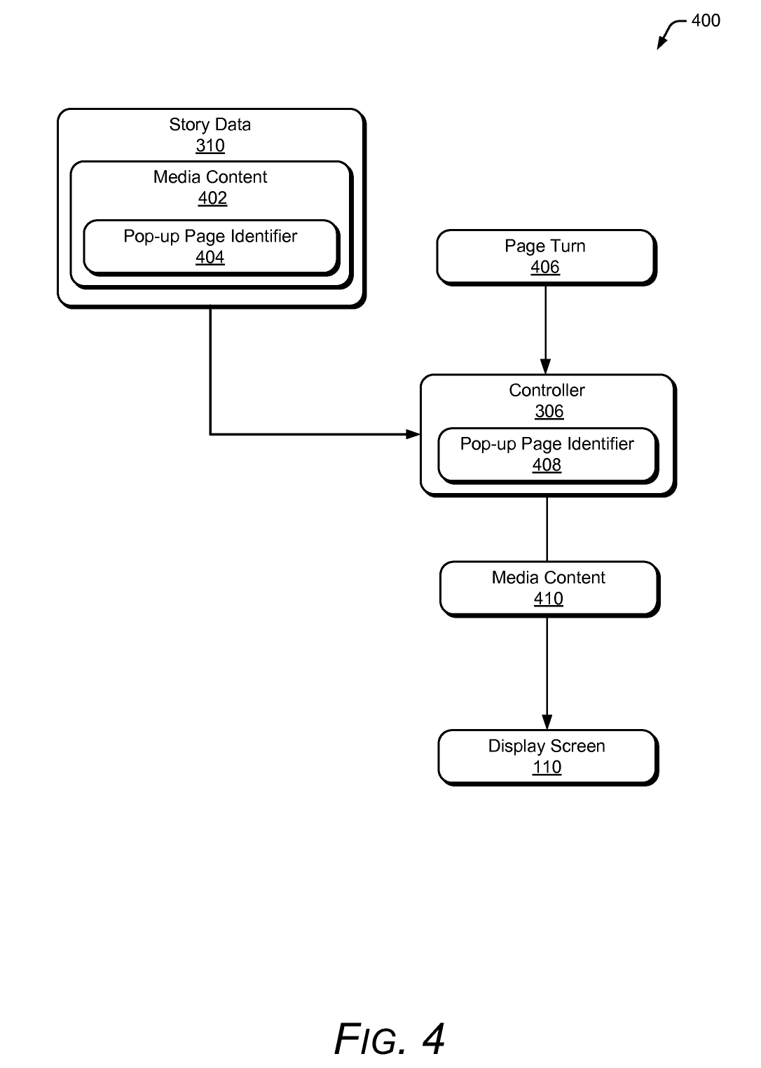

FIG. 4 illustrates a system 400 in an example implementation in which story controller 306 detects pop-up page 108 when positioned in front of display 110, and presents media content associated with pop-up page 108 on display 110.

In this example, computing device 104 receives and loads story data 308 corresponding to book 102. Story data 308 can be received over a network, such as network 314, responsive to computing device 104 communicating a request to download story data 308. For example, the user of computing device 104 may be able to access an online store or marketplace to download story data 308. In one or more implementations, story data 308 may be stored on book 102. In these cases, computing device 104 may access story data 308 via a direct wired or wireless connection to book 102.

Story data 308 includes media content 402 that can be presented on display 110 to visually enhance pop-up pages 108 of book 102. For example, as depicted in FIG. 1, computing device 104 presents media content 112, corresponding to pictures and/or images of the sun, birds, and a child, that interacts with and visually enhances pop-up page 108. As described throughout, media content 402 can include any type of media content, including, video content, images, lighting displays, audio content, and so forth.

Each piece of media content 402 in story data 308 includes an associated pop-up page identifier 404 which associates or maps the piece of media content 402 to a corresponding pop-up page 108 of book 102. In FIG. 1, for example, story data 308 may include media content corresponding to images or video of birds, the sun, and the child, which is associated with pop-up page 108. For example, pop-up page identifier 404 may correspond to an NFC identifier or a pattern of touch input points, as described below with regards to FIGS. 5 and 6, respectively.

As the reader begins interacting with book 102, a page turn 406 occurs, which causes a pop-up page 108 to pop-up in front of display 110, as described above. Story controller 306 detects the presence of pop-up page 108 in front of display 110 by detecting a pop-up page identifier 408 embedded in pop-up page 108. For example, story controller 306 may detect pop-up page identifier 408 when implemented as an NFC tag or a pattern of touch input points, as described below with regards to FIGS. 5 and 6, respectively.

Next, story controller 306 determines media content associated with the detected pop-up page 108. To do so, story controller 306 compares the detected pop-up page identifier 408 to story data 308, and selects media content 410 from story data 308 based on the detected pop-up page identifier 408.

Next, story controller 306 communicates selected media content 410, associated with pop-up page 108, to display 110 to cause display 110 to present media content 410. The presentation of media content 410, by display 110, interacts with and visually enhances pop-up page 108, as described throughout.

FIG. 5 illustrates an example 500 of detecting pop-up page 108 of book 102 in accordance with one or more implementations.

In this example, an NFC tag 502 is embedded into each pop-up page 108 (e.g., into the back of pop-up page 108). Each pop-up page 108 may include a different NFC tag. Page sensor 310 may be implemented as an NFC sensor that is configured to detect NFC tag 502 embedded in pop-up page 108 when pop-up page 108 pops-up in front of display 110. For example, when the reader turns pages 106 of book 102, pop-up page 108 pops-up in front of display 110, and makes contact with, or comes within close proximity to, computing device 104. The close proximity of pop-up page 108 to computing device 104 enables the NFC sensor to detect pop-up page 108 of book 102 by detecting NFC tag 502.

As described above, story data 308 associates media content 402 with NFC tags 502. Thus, responsive to detecting NFC tag 502, story controller 306 selects media content from story data 308 based on the detected NFC tag 502. Story controller 306 then presents the media content, associated with NFC tag 502, on display 110 to visually enhance pop-up page 108, as described throughout.

While example 500 is described with reference to NFC tags, it is to be noted that other types of wireless or unpowered tags may be used in place of NFC tags.

FIG. 6 illustrates an additional example 600 of detecting pop-up page 108 of book 102 in accordance with one or more implementations.

In this implementation, different patterns of touch input points are embedded into the back of pop-up pages 108. In example 600, a pattern of touch input points includes touch input points 602, 604, 606, and 608. Each pop-up page 108 may have a different pattern of touch input points. For example, the size, number, shape, and/or positioning of the touch input points may be different for each pop-up page 108.

To detect the pattern of touch input points, display 110 may be implemented as a multi-touch display (e.g., a capacitive multi-touch display) that is configured to detect multi-touch-input. Touch input points 602, 604, 606, and 608 may be constructed from a capacitive material that is detectable by the multi-touch display.

When the reader turns pages 106 of book 102, pop-up page 108 pops-up and out of book 102, and makes contact with, or comes within close proximity to, display 110. When this occurs, the multi-touch display detects pop-up page 108 of book 102 by detecting the pattern of touch input points 602, 604, 606, and 608.

As described above, story data 308 associates media content 402 with patterns of touch input points. Thus, responsive to detecting the pattern of touch input points 602, 604, 606, and 608, story controller 306 selects media content from story data 308 based on the detected pattern of touch input points. Story controller 306 then presents the media content, associated with the detected pattern of touch input points, on display 110 to visually enhance pop-up page 108, as described throughout.

In some cases, pop-up page 108 may not pop-up and align correctly with display 110. For example, pop-up page 108 may be rotated to the left or right relative to display 110. When this occurs, the media content may not be viewable through pop-up page 108. For example, the child in FIG. 1 may not be viewable through the window if the pop-up page is rotated to the left or the right relative to display 110.

In one or more implementations, story controller 306 is configured to detect the orientation and positioning of pop-up page 108 relative to display 110, and adjust the presentation of the media content to align the media content with the orientation of pop-up page 108 relative to display 110.

Consider, for example, FIG. 7 which illustrates an example of adjusting the presentation of media content on display 110 in accordance with one or more implementations. In this example, media content is presented on display 110, which includes images or video of birds 702-1, the sun 704-1, and a child 706-1. Note, however, that pop-up page 108 is not correctly aligned with display 110 because it is slightly tilted to the right relative to display 110. This causes the presentation of the media content to not be aligned properly with pop-up page 108. For example, birds 702-1 and sun 704-1 are partially blocked by pop-up page 108, and child 706-1 is not positioned in the window.

Story controller 306 is configured to detect the orientation and positioning of pop-up page 108 relative to display 110, and adjust the presentation of the media content to align the media content with the orientation of pop-up page 108 relative to display 110. To do so, story controller 306 can detect the orientation and positioning of pop-up page 108 by detecting the positioning of multiple touch input points on pop-up page 108, such as touch input points 602, 604, 606, and 608. For example, story controller 306 can detect that each of touch input points 602, 604, 606, and 608 are rotated down and to the right of their intended positions.

Story controller 306 then adjusts the presentation of the media content by rotating the media content to conform to the rotation of the detected touch input points. In FIG. 7, for example, story controller 306 rotates the presentation of birds 702-1, sun 704-1, and child 706-1, down and to the right to present adjusted media content, which includes birds 702-2, sun 704-2, and child 706-2. Note that the adjusted media content is aligned correctly with regards to pop-up page 108. For example, birds 702-2 and sun 704-2 are no longer blocked by pop-up page 108, and child 706-2 is positioned in the window of the house.

In some cases, story controller 306 may present the adjusted media content without ever presenting the non-adjusted media content. In FIG. 7, for example, story controller 306 may immediately detect the orientation of pop-up page 108 relative to display 110, and thus does not present the non-adjusted media content on display 110.

In one or more implementations, each pop-up page 108 may include an NFC tag and touch input points. The NFC tag may be used by story controller 306 to identify pop-up page 108, and the touch input points may be used by story controller 306 to adjust the presentation of media content. For example, each page 108 may include an NFC tag, and touch input points, such as touch input points positioned in each corner of pop-up page 108.

Note that that story controller 306 may determine the current pop-up page in different ways than those described above. For example, in one or more implementations, book 102 may be equipped with a page sensor that senses the currently open pages, and communicates sensor data (e.g., via a wired or wireless connection) to computing device 104. For example, the page sensor may be implemented as a flex sensor. Flex sensors are configured to change in resistance or voltage when they flex or bend. For example, the flex sensor may output a high resistance value with a high amount of bend, and a low resistance value with a low amount of bend. Thus, the flex sensor may be attached around the hinge of book 102 to sense the current pages of book 102 that are open. For example, the resistance values of the flex sensor may be mapped to each page of book 102 to enable computing device 104 to determine the current page based on the resistance value of the flex sensor.

Example Methods

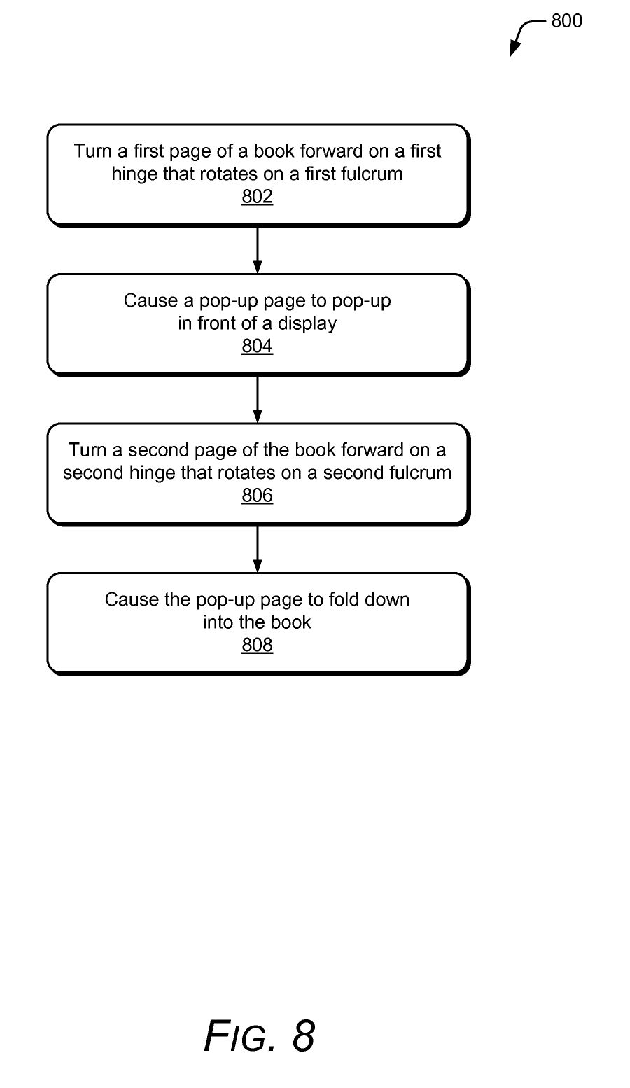

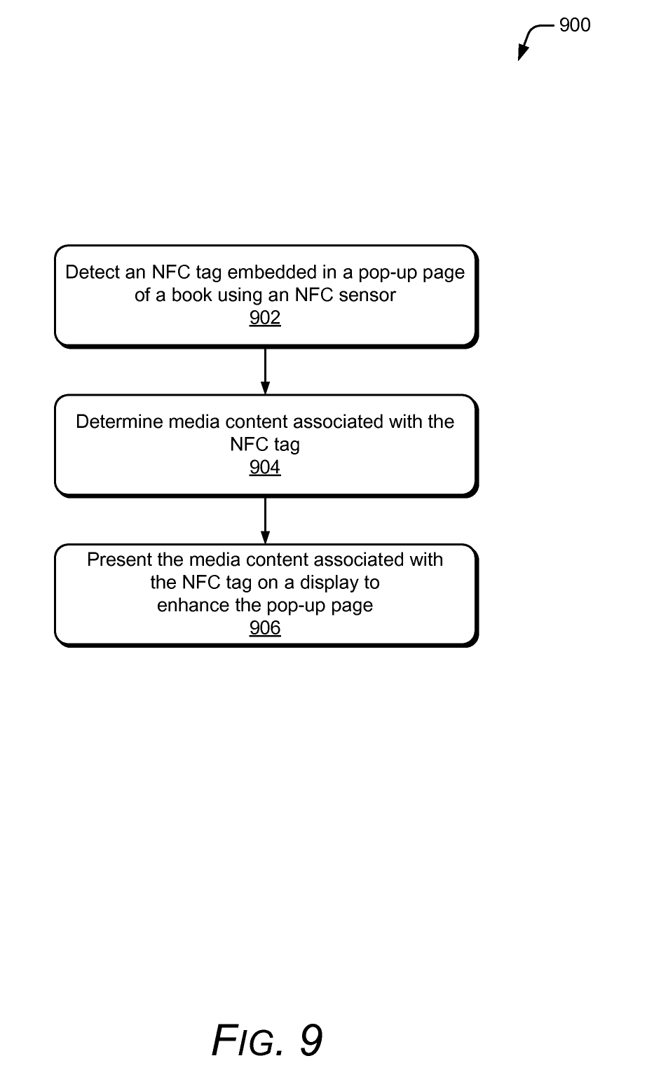

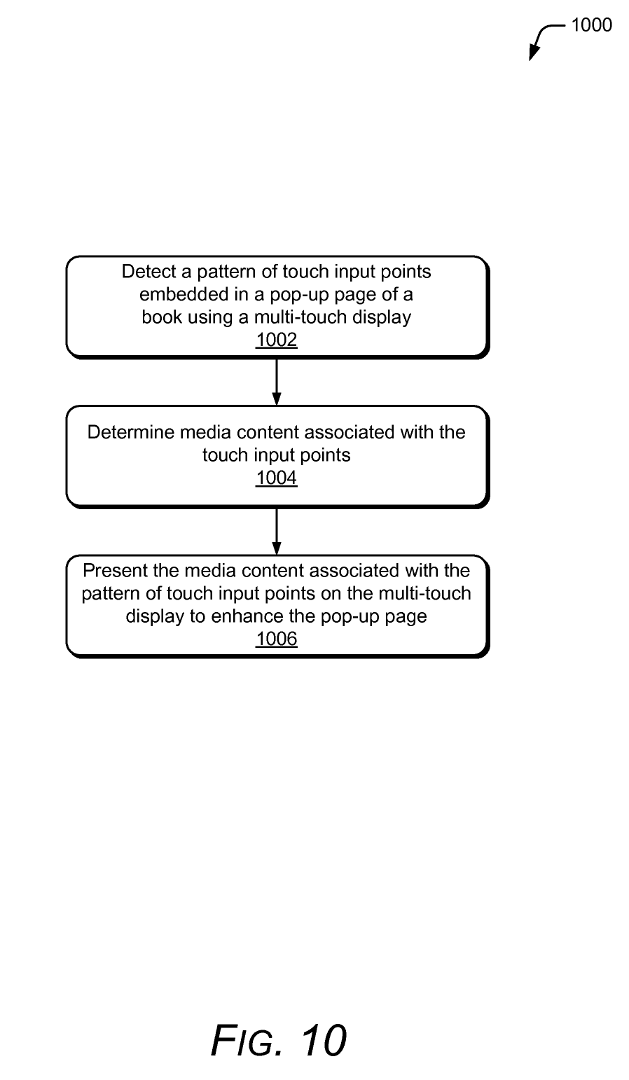

FIG. 8 illustrates an example method 800 of causing a pop-up page to pop-up in front of a display. FIG. 9 illustrates an example method 900 of presenting media content to visually enhance a pop-up page using NFC tags. FIG. 10 illustrates an example method 1000 of presenting media content to visually enhance a pop-up page using a pattern of touch input points. These methods and other methods herein are shown as sets of blocks that specify operations performed but are not necessarily limited to the order or combinations shown for performing the operations by the respective blocks. In portions of the following discussion reference may be made to environment 100 of FIG. 1, example 200 of the pop up system of book 102 of FIGS. 2a and 2b, example 300 of computing device 104 of FIG. 3, and system 400 of FIG. 4, reference to which is made for example only. The techniques are not limited to performance by one entity or multiple entities operating on one device.

FIG. 8 illustrates an example method 800 of causing a pop-up page to pop-up in front of a display. At 802, a first page of a book is turned forward on a first hinge that rotates on a first fulcrum. For example, a user turns first page 106-1 of book 102 forward on a first hinge 206 that rotates on a first fulcrum.

At 804, a pop-up page is caused to pop-up in front of a display. For example, pop-up mechanism 204 causes pop-up page 108 to pop-up in front of display 110 responsive to first page 106-1 of book 102 being turned forward on first hinge 206.

At 806, a second page of the book is turned forward on a second hinge that rotates on a second fulcrum. For example, the user turns second page 106-2, which is adjacent to first page 106-1, of book 102 forward on a second hinge 208 that rotates on a second fulcrum.

At 808, the pop-up page is caused to fold down into the book. For example, pop-up mechanism 204 causes pop-up page 108 to fold down into book 102 responsive to second page 106-2 of book 102 being turned backward on second hinge 208.

FIG. 9 illustrates an example method 900 of presenting media content to visually enhance a pop-up page using NFC tags.

At 902, an NFC tag embedded in a pop-up page of a book is detected by a computing device using an NFC sensor when the pop-up page pops-up in front of a display of the computing device. For example, page sensor 310, implemented as an NFC sensor, detects NFC tag 502 embedded in pop-up page 108 of book 102 when pop-up page 108 pops-up in front of display 110 of computing device 104.

At 904, media content associated with the NFC tag is determined. For example, story controller 306 of computing device 104 determines media content 402 by comparing the detected NFC tag to story data 308.

At 906, the media content associated with the NFC tag is presented on the display to visually enhance the pop-up page. For example, computing device 104 presents media content associated with NFC tag 502 on display 110 positioned behind pop-up page 108 to visually enhance the pop-up page.

FIG. 10 illustrates an example method 1000 of presenting media content to visually enhance a pop-up page using a pattern of touch input points.

At 1002, a pattern of touch input points embedded in a pop-up page of a book is detected by a multi-touch display of a computing device when the pop-up page pops-up in front of the multi-touch display. For example, display 110 of computing device 104, when implemented as a multi-touch display, detects a pattern of touch input points 602, 604, 606, and 608 embedded in pop-up page 108 of book 102 when pop-up page 108 pops-up in front of the multi-touch display.

At 1004, media content associated with the pattern of touch input points is determined. For example, story controller 306 of computing device 104 determines media content associated with pattern of touch input points 602, 604, 606, and 608 in story data 310.

At 1006, the media content associated with the pattern of touch input points is presented on the multi-touch display to visually enhance the pop-up page. For example, computing device 104 presents media content associated with the pattern of touch input points 602, 604, 606, and 608 on multi-touch display 110 positioned behind pop-up page 108 to visually enhance the pop-up page.

Example Computing System

FIG. 11 illustrates various components of an example computing system 1100 that can be implemented as any type of client, server, and/or computing device as described with reference to the previous FIGS. 1-10 to implement book 102 and/or computing device 104. In embodiments, computing system 1100 can be implemented as one or a combination of a wired and/or wireless wearable device, System-on-Chip (SoC), and/or as another type of device or portion thereof. Computing system 1100 may also be associated with a user (e.g., a person) and/or an entity that operates the device such that a device describes logical devices that include users, software, firmware, and/or a combination of devices.

Computing system 1100 includes communication devices 1102 that enable wired and/or wireless communication of device data 1104 (e.g., received data, data that is being received, data scheduled for broadcast, data packets of the data, etc.). Device data 1104 or other device content can include configuration settings of the device, media content stored on the device, and/or information associated with a user of the device. Media content stored on computing system 1100 can include any type of audio, video, and/or image data. Computing system 1100 includes one or more data inputs 1106 via which any type of data, media content, and/or inputs can be received, such as human utterances, user-selectable inputs (explicit or implicit), messages, music, television media content, recorded video content, and any other type of audio, video, and/or image data received from any content and/or data source.

Computing system 1100 also includes communication interfaces 1108, which can be implemented as any one or more of a serial and/or parallel interface, a wireless interface, any type of network interface, a modem, and as any other type of communication interface. Communication interfaces 1108 provide a connection and/or communication links between computing system 1100 and a communication network by which other electronic, computing, and communication devices communicate data with computing system 1100.

Computing system 1100 includes one or more processors 1110 (e.g., any of microprocessors, controllers, and the like), which process various computer-executable instructions to control the operation of computing system 1100 and to enable techniques for, or in which can be embodied, book 102 and computing device 104. Alternatively or in addition, computing system 1100 can be implemented with any one or combination of hardware, firmware, or fixed logic circuitry that is implemented in connection with processing and control circuits which are generally identified at 1112. Although not shown, computing system 1100 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 1100 also includes computer-readable media 1114, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 1100 can also include a mass storage media device 1116.

Computer-readable media 1114 provides data storage mechanisms to store device data 1104, as well as various device applications 1118 and any other types of information and/or data related to operational aspects of computing system 1100. For example, an operating system 1120 can be maintained as a computer application with computer-readable media 1114 and executed on processors 1110. Device applications 1118 may include a device manager, such as any form of a control application, software application, signal-processing and control module, code that is native to a particular device, a hardware abstraction layer for a particular device, and so on.

Device applications 1118 also include any system components, engines, or managers to implement book 102 and/or computing device 104. In this example, device applications 1118 include story controller 306.

### CONCLUSION

Although embodiments of a media enhanced pop-up book and techniques and devices for presenting media content to visually enhance a pop-up book have been described in language specific to features and/or methods, it is to be understood that the subject of the appended claims is not necessarily limited to the specific features or methods described. Rather, the specific features and methods are disclosed as example implementations of a media enhanced pop-up book and techniques and devices for presenting media content to visually enhance a pop-up book.

What is claimed is:

1. A computing device, comprising:
a display;
a computer processor; and
a computer-readable storage medium comprising instructions stored thereon that, responsive to execution by the computer processor, implement a story controller configured to:
detect a pop-up page of a book when the pop-up page pops-up in front of the display; and
present media content associated with the detected pop-up page on the display to visually enhance the pop-up page, the media content viewable through the pop-up page.

2. The computing device as recited in claim 1, wherein the computing device further comprises an NFC sensor that is configured to detect an NFC tag embedded in the pop-up page when the pop-up page pops-up in front of the display, and wherein the story controller detects the pop-up page of the book based on the detected NFC tag.

3. The computing device as recited in claim 2, wherein the story controller is further configured to select the media content from story data associated with the book, the story data associating media content with different NFC tags.

4. The computing device as recited in claim 1, wherein the display comprises a multi-touch display that is configured to detect a pattern of touch input points embedded in the pop-up page such that when the pop-up page pops-up in front of the multi-touch display the story controller detects the pop-up page of the book based on the detected pattern of touch-input points.

5. The computing device as recited in claim 4, wherein the story controller is further configured to select the media content from story data associated with the book, the story data associating media content with different patterns of touch input points.

6. The computing device as recited in claim 4, wherein the story controller is further configured to detect an orientation of the pop-up page relative to the display based on the detected pattern of touch input points.

7. The computing device as recited in claim 6, wherein the story controller is further configured to adjust the presentation of the media content based on the orientation of the pop-up page relative to the display.

8. The computing device as recited in claim 1, wherein the story controller is configured to present the media content on the display such that the media content is viewable through cut-outs in the pop-up page.

9. The computing device as recited in claim 1, wherein the computing device comprises one of a tablet computing device or a smartphone.

10. A method comprising:
detecting, by a computing device, an NFC tag embedded in a pop-up page of a book using an NFC sensor when the pop-up page pops-up in front of a display of the computing device;
determining media content associated with the NFC tag; and
presenting the media content associated with the NFC tag on the display to visually enhance the pop-up page.

11. The method as recited in claim 10, wherein the presenting the media content further comprises presenting the media content such that at least a portion of the media content is viewable through cut-outs in the pop-up page.

12. The method as recited in claim 10, wherein the determining the media content associated with the NFC tag further comprises:
comparing the detected NFC tag to story data that associates media content with different NFC tags; and
selecting the media content associated with the detected NFC tag in the story data.

13. The method as recited in claim 10, wherein the display comprises a multi-touch display, and wherein the method further comprises detecting, by the multi-touch display, an orientation of the pop-up page relative to the multi-touch display by detecting one or more touch input points embedded in the pop-up page.

14. The method as recited in claim 13, further comprising adjusting the presentation of the media content based on the detected orientation of the pop-up page relative to the display to align the media content with the orientation of the pop-up page.

15. The method as recited in claim 10, wherein the media content comprises images or video.

16. A method comprising:
detecting, at a computing device, a pattern of touch input points embedded in a pop-up page of a book using a multi-touch display of the computing device when the pop-up page pops-up in front of the multi-touch display;
determining media content associated with the pattern of touch input points; and
presenting the media content associated with the pattern of touch input points on the multi-touch display to visually enhance the pop-up page.

17. The method as recited in claim 16, wherein the presenting the media content further comprises presenting the media content such that at least a portion of the media content is viewable through cut-outs in the pop-up page.

18. The method as recited in claim 16, wherein the determining the media content further comprises:
comparing the pattern of touch input points to story data that associates media content with different patterns of touch input points; and
determining the media content based on the media content being associated with the detected pattern of touch input points in the story data.

19. The method as recited in claim 16, further comprising, prior to the presenting, detecting an orientation of the pop-up page relative to the multi-touch display based on the pattern of touch input points.

20. The method as recited in claim 19, wherein the presenting further comprises adjusting the presentation of the media content such that the media content is aligned with the orientation of the pop-up page relative to the multi-touch display.
